(19) United States
(12) Patent Application Publication
(10) Pub. No.: US 2016/0037133 A1
(43) Pub. Date: Feb. 4, 2016

(54) REAL-TIME MANAGEMENT OF DATA RELATIVE TO AN AIRCRAFT'S FLIGHT TEST

(71) Applicant: Airbus Operations (SAS), Toulouse (FR)

(72) Inventors: Jean-Luc Vialatte, Toulouse (FR); Sophie Calvet, Fonsorbes (FR)

(21) Appl. No.: 14/811,165

(22) Filed: Jul. 28, 2015

(30) Foreign Application Priority Data
Jul. 31, 2014 (FR) 1457472

(51) Int. Cl. H04N 7/18; G06T 11/00; H04N 5/232; G06K 9/62; H04N 5/44; G06T 3/00; G06K 9/46; G06K 9/00

(52) U.S. Cl. CPC H04N 7/183; G06K 9/46; G06T 11/001; G06K 9/00624; G06K 9/6201; H04N 5/44; G06T 3/00; G06K 9/4604; H04N 5/23293; G06K 2009/4666

(57) ABSTRACT

Automated processing of images onboard an aircraft and a system for real-time management of data relating to an in-flight test of aerodynamic behaviors of the aircraft. Flow cones are installed on at least one area of interest of the aircraft to be analyzed in the in-flight test. Indicators are installed in the area of interest defining a delimitation of the area of interest. Image capturing devices are installed in the aircraft and are configured to capture a stream of images of the area of interest on which the flow cones and the indicators are installed. A processor is configured to process, in real time and onboard the aircraft, each current image of the stream of images to automatically identify and determine positions of the indicators and positions of at least some of the flow cones.

### CROSS-REFERENCES TO RELATED APPLICATIONS

This application claims the benefit of the French patent application No. 1457472 filed on Jul. 31, 2014, the entire disclosures of which are incorporated herein by way of reference.

### BACKGROUND OF THE INVENTION

The present invention relates to the field of the in-flight testing of an aircraft and, more particularly, relates to an acquisition of images relating to an in-flight test of aerodynamic behaviors of an aircraft, an automatic processing of these images onboard the aircraft and, advantageously, a real-time transmission of processed data.

In order to analyze the aerodynamic flow of an aircraft, flow cones are installed on areas of the aircraft for which the analyses are required. The flow cones are elements that can take the form of a cone attached, for example, by wires to a part of the aircraft that exhibit, because of their lightness, characteristic movements according to the type of aeronautical flight and whose form allows for visualization in a video recording. These flow cones are filmed by cameras installed in the cabin behind a window, or cameras installed outside the aircraft. The images are recorded onboard the aircraft and are unloaded after landing to be then used and analyzed by experts on the ground.

After the images have been manually analyzed, the experts may sometimes find that the test is insufficient and that others are required, for example according to other flight configurations. In this case, the aircraft must take off again to conduct other tests.

In order to limit the number of in-flight tests, the transmission system is adapted to send up to two images per second to the ground in real time. The usable bandwidth is fairly small and does not allow for the transmission of a large number of images. This limited number of images does not allow the observer on the ground to correctly analyze the movements of the cones and does not make it possible to know if the test is conclusive.

### SUMMARY OF THE INVENTION

An object of the present invention is consequently to allow for an exhaustive and accurate analysis of the movement of the flow cones and thereby of the aerodynamic behavior of the aircraft. Another aim is to enable this analysis to be conducted in real time and on the ground with a limited quantity of data transmitted to the ground thus making it possible to reduce the number of in-flight tests, the flight time and the costs.

The present invention aims to automate the analysis of images taken in flight onboard an aircraft and relates to a system for real-time management of data relating to the in-flight test, comprising:
flow cones installed on at least one area of interest of the aircraft intended to be analyzed during the in-flight test,
indicators installed in said area of interest defining a delimitation of said area of interest,
image capture means associated with the aircraft and configured to capture a stream of images of said area of interest on which the flow cones and the indicators are installed, and
processing means intended to process, in real time and onboard the aircraft, each current image of said stream of images to automatically identify and determine positions of said indicators and positions of at least some of said flow cones.

This system provides the experts who are following the test with information in real time on the precise movement of the flow cones, consequently enabling them to deduce therefrom the aerodynamic behavior of the aircraft and thus be able to conduct the test in real time by guiding the crew notably, for example, in the choice of configurations of the flight controls (tips, flaps, etc.), thus reducing the necessary test flight hours.

Advantageously, the system comprises transmission means configured to transmit to the ground, in real time, data relating to said positions of the indicators and of said at least some of the cones.

This makes it possible to provide experts who are following the test on the ground with information in real time (transmitted to the ground in a limited quantity of data) on the movement of the flow cones, enabling them to transmit to the crew accurate information concerning the conducting of the test in real time.

Advantageously, the processing means are configured to automatically determine only the positions of the flow cones that have started moving, the positions of said at least some of said cones transmitted to the ground correspond to the positions of the flow cones which have started moving.

According to one embodiment, said indicators are formed by a subset of flow cones.

According to a preferred embodiment of the present invention, the processing means comprise:
an image processing module configured to identify the indicators by transforming said current image into a first binary image representing the indicators on a monochrome background, and
an analysis module configured to analyze said first binary image and said current image to determine the positions of the indicators and of the flow cones.

Advantageously, the image processing module comprises:
a selection block configured to take as input said current image and to extract from said current image a color characterizing the indicators, thus forming, as output, an image restricted to said indicators,
a colorimetric conversion block configured to take as input said current image and to produce as output a first greyscale image corresponding to said current image,
a subtraction block configured to take as input the outputs of said selection and conversion blocks and to subtract said greyscale first image from said restricted image producing, as output, a second greyscale image restricted to the indicators,
a first thresholding block configured to take as input said second greyscale image and to form as output said first binary image representing the indicators on a monochrome background.

Advantageously, the analysis module comprises:
a first detection block configured to take as input said first binary image representing the indicators and to produce as output coordinates of points representing the positions of said indicators,
a transformation block configured to determine a projective transformation matrix associating, with each point representing the position of an indicator, a point on a rectangular contour of said first binary image,
a first projection block configured to apply said projective transformation matrix onto the first greyscale image transforming the area of interest of said first greyscale image into a rectangular area of interest delimited by said rectangular contour, thus producing as output a third greyscale image delimited by the rectangular contour and representing the flow cones of said rectangular area of interest,
a second thresholding block configured to take as input said third greyscale image forming as output a second binary image corresponding to said third greyscale image and representing the flow cones of said rectangular area of interest on a monochrome background,
a second projection block configured to apply an inverse matrix of said projective transformation matrix onto said second binary image producing a third binary image without any object outside of the area of interest, and
a second detection block configured to take as input said third binary image and to produce as output coordinates indicating the positions of said flow cones.

Advantageously, the analysis module further comprises a comparison block configured to compare the positions of the flow cones of said third current binary image with those of the preceding image thus automatically identifying the flow cones which start to move such that the positions of said at least some of said cones transmitted to the ground relate to the flow cones which have started moving.

Advantageously, the processing means further comprise a display module comprising:
a first graphic representation block configured to take as input said current image and the data relating to the positions of said at least some of the cones and to draw on said current image contours delimiting the detected cones, forming as output a first reconstruction image,
a second graphic representation block configured to take as input said first reconstruction image and the data relating to the positions of the indicators and to draw on said first reconstruction image points representing the positions of the indicators, forming as output a second reconstruction image,
a third graphic representation block configured to take as input said second reconstruction image and to delimit said area of interest by drawing on said second reconstruction image lines linking the points representing the positions of the indicators forming as output a final reconstruction image.

The invention also targets an operating system for data relating to an in-flight test received in real time from an aircraft, said data being acquired according to any one of the above features, said operating system comprising:
a transceiver unit configured to receive, in real time from the aircraft, said data relating to the positions of the indicators and of said at least some of the flow cones,
a data processing unit configured to display the positions of the indicators on a drawing representing the part of the aircraft comprising the area of interest.

The invention also targets a system for analyzing aerodynamic behaviors of an aircraft, comprising the management system and the operating system according to any one of the above features.

The invention also targets an aircraft comprising the management system according to any one of the above features.

The invention also targets a method for processing, in real time, a stream of images taken onboard an aircraft in an in-flight test of aerodynamic behaviors of said aircraft, said images relating to an area of interest of the aircraft on which flow cones and indicators are installed, said method comprising processing, in real time and onboard the aircraft, of each current image of said stream of images to automatically identify and determine positions of said indicators and positions of at least some of said flow cones.

Advantageously, the method comprises a step of transmission, to the ground in real time, of data relating to said positions of the indicators and of said at least some of the cones.

Advantageously, the method comprises the following steps:
identification of the indicators by transforming each current image of said stream of images into a first binary image representing the indicators on a monochrome background, and
analysis of said first binary image and of said current image to determine the positions of the indicators and of the flow cones.

Advantageously, the identification of the indicators comprises the following steps:
extraction of a color characterizing the indicators of said current image to form an image restricted to said indicators,
production of a first greyscale image corresponding to said current image,
subtraction of said first greyscale image from said restricted image to produce a second greyscale image restricted to the indicators,
thresholding of said second greyscale image to form said first binary image representing the indicators on a monochrome background.

Advantageously, the analysis of said first binary image and of said current image for the determination of the positions of the indicators and of the flow cones comprises the following steps:
determination of coordinates of the points representing the positions of said indicators from said first binary image,
determination of a projective transformation matrix associating, with each point representing the position of an indicator, a point on a rectangular contour of said first binary image,
application of said projective transformation matrix onto the first greyscale image to transform the area of interest of said first greyscale image into a rectangular area of interest delimited by said rectangular contour thus producing a third greyscale image delimited by the rectangular contour and representing the flow cones of said rectangular area of interest,
thresholding of said third greyscale image to form a second binary image representing the flow cones of said rectangular area of interest on a monochrome background,
application of an inverse matrix of said projective transformation matrix onto said second binary image to produce a third binary image without any object outside of the area of interest, and
determination of the coordinates indicating the positions of said flow cones from said third binary image.

Advantageously, the processing method further comprises a comparison of the positions of the flow cones of said third current binary image with those of the preceding image to automatically identify the flow cones which start to move.

Advantageously, the processing method further comprises the following steps:
drawing of contours delimiting the flow cones on said current image to form a first reconstruction image,
drawing of points representing the positions of the indicators on said first reconstruction image to form a second reconstruction image,
drawing of the lines linking the points representing the positions of the indicators on said second reconstruction image to form a final reconstruction image.

The invention also targets a computer program comprising code instructions for the implementation of the processing method according to the above features when it is run by processing means.

### BRIEF DESCRIPTION OF THE DRAWINGS

Other features and advantages of the system and of the method according to the invention will become more apparent on reading the following description, given by way of indication and in a nonlimiting manner, with reference to the attached drawings in which:

FIG. 1 schematically illustrates a system for real-time management of data relating to an in-flight test of aerodynamic behaviors of an aircraft, according to an embodiment of the invention.

FIGS. 2A-2D illustrate the steps of a method for real-time management of data relating to an in-flight test, according to an embodiment of the invention.

FIG. 3 schematically illustrates an operating method for data relating to an in-flight test received from an aircraft, according to an embodiment of the invention;

FIGS. 4A-4C schematically illustrate the processing means of the management system of FIG. 1, according to a preferred embodiment of the invention;

FIGS. 4D and 4E schematically illustrate the processing means of the management system of FIG. 1, according to another preferred embodiment of the invention; and

FIG. 5 schematically illustrates a system for analyzing aerodynamic behaviors of an aircraft, according to a preferred embodiment of the invention.

### DETAILED DESCRIPTION OF THE PREFERRED EMBODIMENTS

A principle of the invention notably makes it possible to automate the processing of images captured during an in-flight test to determine, in real time, the positions of the flow cones. Advantageously, this makes it possible to transmit to the ground, in real time, only the positions of the flow cones, thus allowing for, with the help of a limited sending of data from the aircraft to the ground, an automatic analysis of the aerodynamic behaviors of parts of the aircraft on which the flow cones are installed.

FIG. 1 schematically illustrates a system for real-time management of data relating to an in-flight test of aerodynamic behaviors of an aircraft, according to an embodiment of the invention.

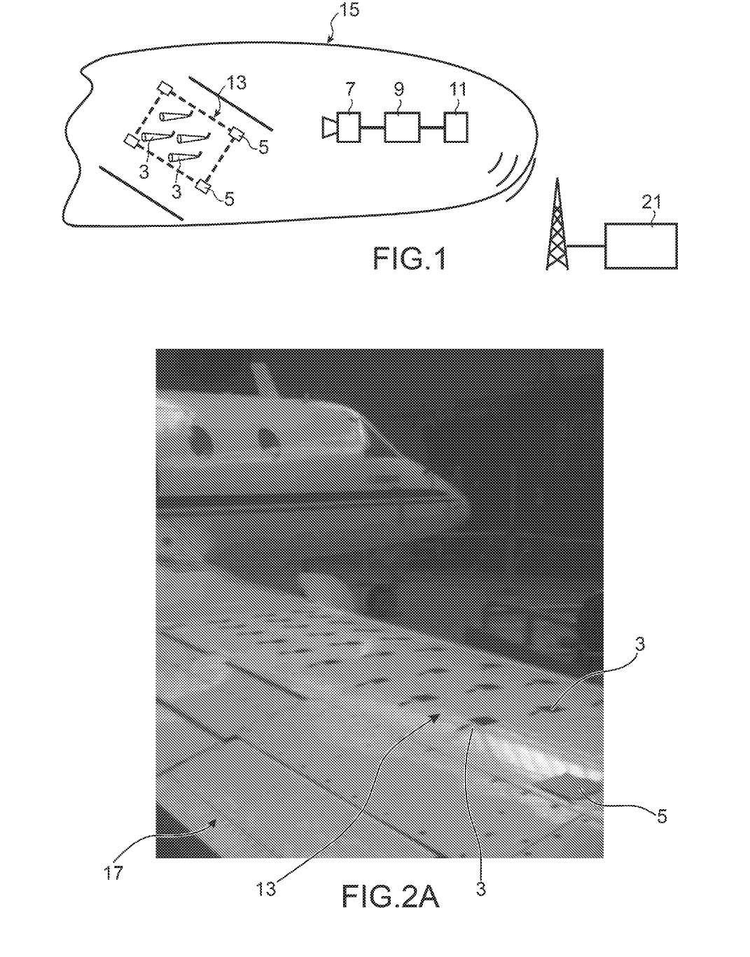

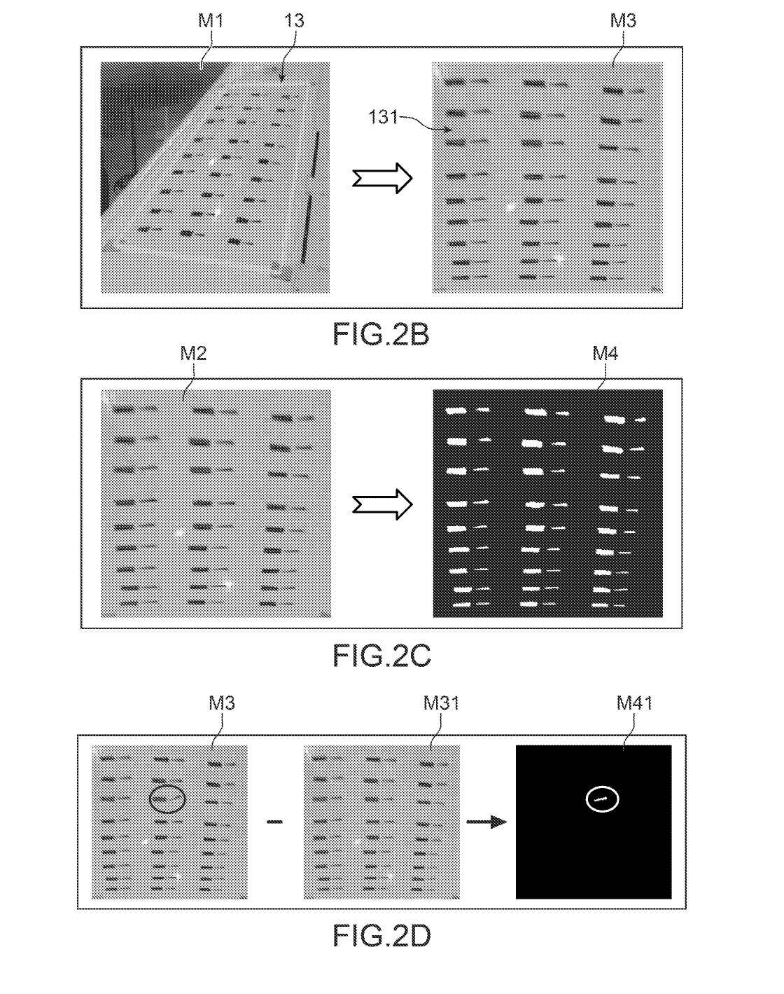

Furthermore, FIGS. 2A-2D illustrate the steps of a method for real-time management of data relating to an in-flight test, according to an embodiment of the invention.

According to the invention, the management system 1 comprises a set of flow cones 3, a set of indicators 5, image capture means 7, and processing means 9.

The flow cones 3 are installed on at least one area of interest 13 (for example, on a part of the wings) of the aircraft 15 intended to be analyzed during an in-flight test.

FIG. 2A shows, by way of example, flow cones fixed onto a predetermined part of a wing 17 of the aircraft 15 in order to analyze the aerodynamic behavior thereon. It will be noted that the flow cones 3 are light elements which exhibit, when they are attached onto a part of the fuselage of the aircraft 15, known characteristic movements depending on the type of aerodynamic flow which is applied to them.

The indicators (or targets) 5 are installed in the area of interest 13 to define a delimitation of this area 13. This delimitation is generally in the form of a quadrilateral (rectangle, parallelogram, square, etc.). In particular, in order to allow the automatic detection of the flow cones 3, the indicators 5 are installed around the area of installation of these cones 3. For example, an indicator 5 is installed on each corner of the quadrilateral delimiting this area 13. Furthermore, in order to automatically identify the indicators 5, the latter are characterized by predetermined specific physical characteristics relating, for example, to their color, their shape, their pattern, etc. Advantageously, indicators 5 are chosen that have a primary color that does not appear much in the environment of the aircraft in-flight. For example, the indicators can be chosen to be of green color and of a particular geometrical shape.

According to a variant, the indicators 5 are formed by the flow cones 3 themselves or by at least those which are at the edge of the area of interest 13. In this case, this set or subset of flow cones 3 is characterized by a specific color that does not appear much in the environment of the aircraft. Hereinbelow, the term “indicator” will designate any element whose function is to identify the area of interest regardless of whether this element is or is not distinct from a flow cone 3.

The image capture means comprises cameras 7 associated with the aircraft 15 and configured to capture a stream of color images of the area of interest 13 on which the flow cones 3 and the indicators 5 are installed. The cameras 7 are installed, for example, in the cabin of the aircraft 15 behind a window and/or outside the aircraft in a manner suitable for filming the flow cones 3 and the indicators 5.

The processing means 9 comprises, for example, a computer or an embedded computer comprising an input unit, computation and data processing unit, storage means, and an output unit. It will be noted that the storage means can include a computer program comprising code instructions suitable for implementing the acquisition, processing and transmission method according to the invention.

The processing means 9 are intended to process, in real time and onboard the aircraft 15, each current image M1 of the stream of images captured by the image capture means 7 to automatically identify and determine the positions of the indicators 5 delimiting or defining the area of interest 13 and the positions of at least some of the flow cones 3.

In particular, the processing means 9 are configured to identify the area of interest 13 through, for example, the distinctive color of the indicators 5. Furthermore, in order to be free of effects that can disturb the aerodynamic analysis, the processing means are configured to project the area of interest 13 of the current image M1 onto a planar surface forming a projection area having a predetermined geometrical form. In effect, FIG. 2B shows that the area of interest 13 of the current image M1 is projected onto a planar surface to form the image M3 comprising a projection area 131 of square form.

Once the area of interest 13 has been identified and projected, the processing means 9 are configured to apply a thresholding to the image M3 in order to obtain a binary image M4 (i.e., dichromatic) as illustrated in FIG. 2C thus facilitating the automatic detection of the positions of the flow cones 3.

Thus, this management system provides experts onboard the aircraft with accurate and real-time information on the orientation and the amplitude of the movement of each flow cone 3 enabling them to deduce therefrom the aerodynamic behavior of the aircraft and thus be able to conduct the test in real time.

According to a first variant, the processing means 9 are configured to identify and determine, on each current image M1, the positions of all the flow cones 3.

According to a second variant, the processing means 9 are configured to identify and determine, on each current image M1, only the positions of the flow cones 3 which have been detected in motion relative to the preceding image. More particularly, each projected image M3 corresponding to a current image M1 is compared to the preceding one M31 in order to improve the location of the flow cones and detect their movement. Then, a thresholding is applied to the resultant image in order to obtain a binary image M41 comprising the flow cones 3 in motion as illustrated in FIG. 2D.

According to a preferred embodiment of the present invention, the management system comprises transmission means 11 which are configured to transmit, to the ground in real time, the data relating to the positions of the indicators 5 and those relating to the positions of all the flow cones 3 (according to the first variant) or only the positions of those which have moved (according to the second variant).

Thus, according to the first variant, the images captured by the image capture means 7 are processed in real time onboard the aircraft 15 and the positions of the indicators 5 and of all the flow cones 3 are transmitted by the transmission means 11 to a station 21 on the ground.

According to the second variant, the images are also processed in real time onboard the aircraft 15, but only the positions of the flow cones 3 which have been detected in motion and the positions of the indicators 5 are transmitted to the station 21 on the ground making it possible to further reduce the quantity of data transmitted to the ground.

Thus, according to this preferred embodiment, the management system transmits, in real time to the experts who are following the test on the ground, a limited quantity of data representative of the movement of the flow cones enabling them consequently to deduce therefrom the aerodynamic behavior of the aircraft and thus be able to guide the crew in conducting the test in real time.

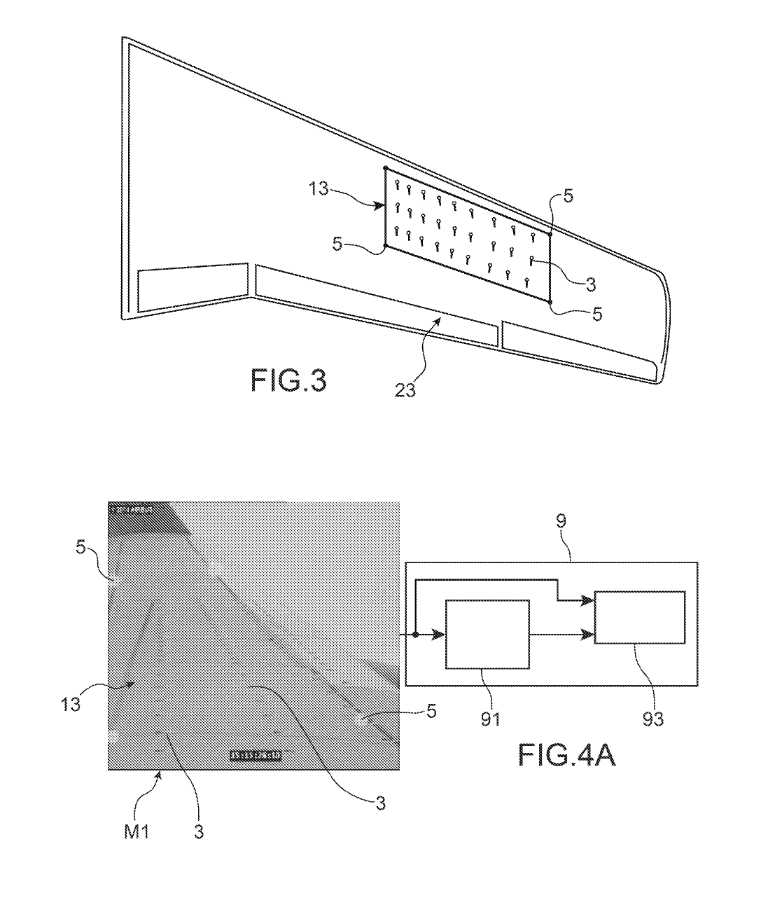

FIG. 3 schematically illustrates an operating method for data relating to an in-flight test received from an aircraft, according to an embodiment of the invention.

The positions of the flow cones 3 and those of the indicators 5, received on the ground, are displayed on a drawing 23 representing the part of the aircraft filmed by the image capture means 7. This enables the people specializing in aerodynamic tests who are following the test on the ground to have real-time information on the movements of the flow cones 3 installed on the aircraft 15. Furthermore, this information helps the experts to guide the crew of the aircraft 15 in real time during the test and in particular to guide them from the ground on the choice of configuration of the flight control means (tips, flaps, etc.) of the aircraft thus making it possible to reduce the necessary test flight hours.

Moreover, the images captured onboard the aircraft 15 and the positions of the indicators 5 and of the flow cones 3 corresponding to the successive images originating from the processing means 9 are recorded, for example, in the storage means. This enables the experts on the ground to view the movements of the flow cones 3 offline, for example to confirm their analysis or verify an aerodynamic behavior not easily analyzed in real time.

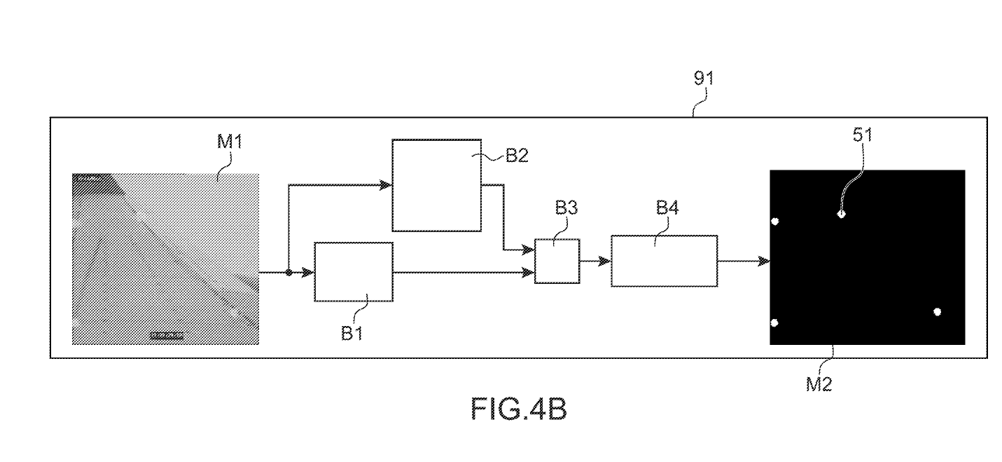

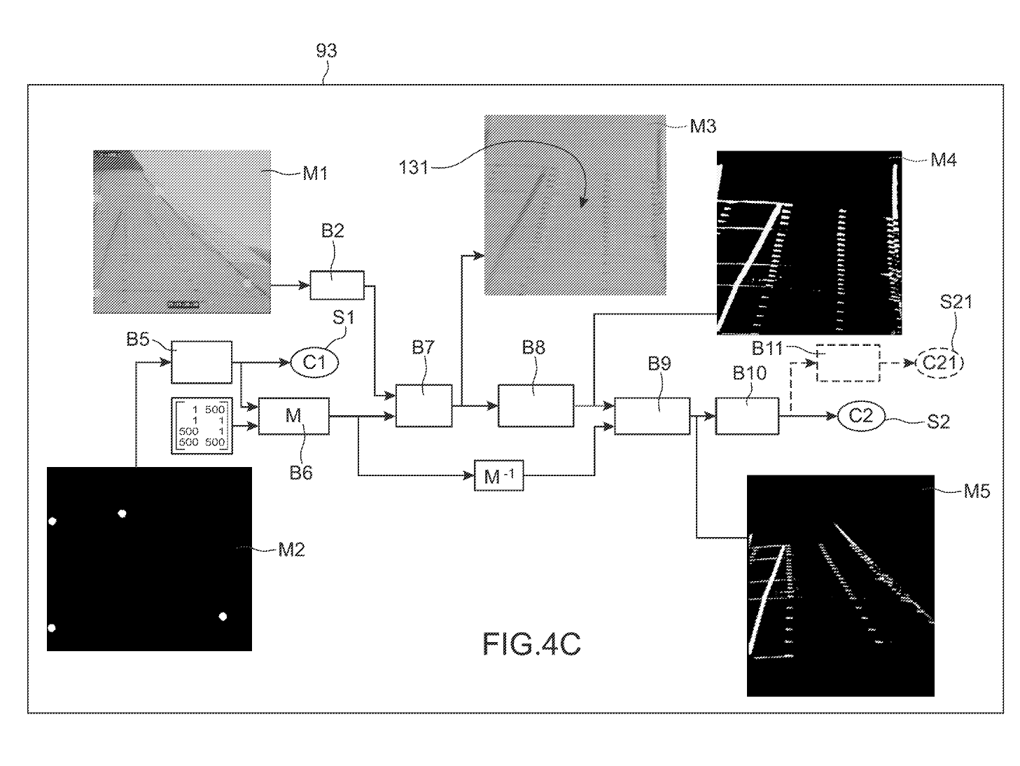

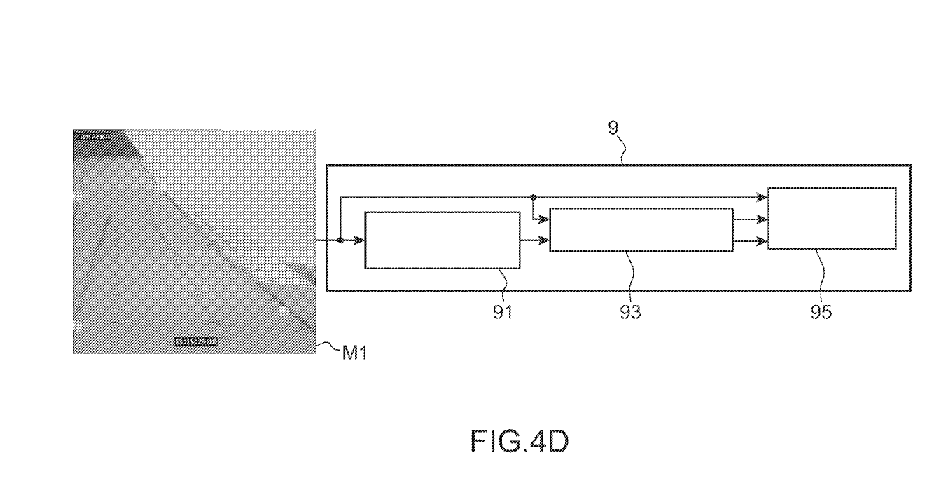

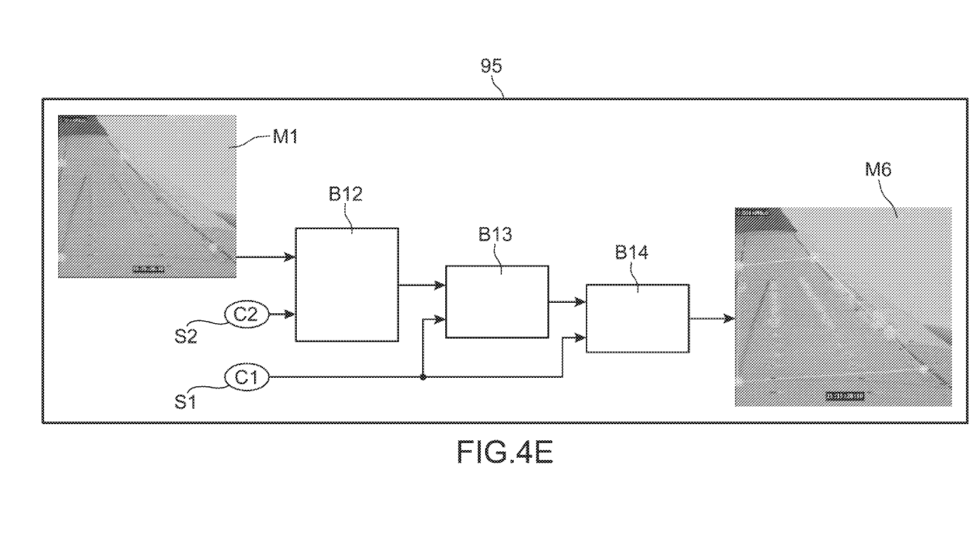

FIGS. 4A-4C schematically illustrate the processing means of the management system of FIG. 1, according to a preferred embodiment of the invention.

FIG. 4A shows that the processing means comprise an image processing module 91 and an analysis module 93.

The image processing module 91 is configured to identify the indicators 5 by transforming each current image M1 captured by the cameras 7 into a first binary image M2 (see FIG. 4B) representing the indicators 5 detected on a monochrome background.

More particularly, FIG. 4B shows that the image processing module 91 comprises a selection block B1, a colorimetric conversion block B2, a subtraction block B3, and a first thresholding block B4.

The selection block B1 is configured to take as input the current image M1 captured by the cameras 7 and to extract a color characterizing the indicators 5 out of the primary colors of this current image M1. According to this example, the current image M1 shows a wing of an airplane with flow cones 3 installed on an area of interest 13 of the wing gridded by four indicators 5.

The current image M1 is a matrix made up of three primary colors and the selection block B1 selects the component (for example, green) characterizing the indicators 5 thus forming as output an image (not represented) restricted to the indicators 5.

The colorimetric conversion block B2 is configured to take as input the current image M1 and to convert the colorimetric space of this image M1 into greyscale. Thus, the colorimetric conversion block produces as output a first greyscale image (not represented) corresponding to the current image M1.

The subtraction block B3 is configured to take as input the outputs of the selection B1 and conversion B2 blocks and to subtract the first greyscale image from the restricted image, producing as output a second greyscale image (not represented) restricted to the indicators 5. In effect, the subtraction makes it possible to subtract the averaged image (i.e., second greyscale image) from the restricted image having the color of interest (for example, the color green) in order to increase the contrast of the objects which have this color of interest.

The first thresholding block B4 is configured to take as input the second greyscale image restricted to the indicators and to form as output the first binary image M2 representing the indicators detected on a monochrome background. The first binary image M2 illustrated in the example of FIG. 4B shows four white points 51 representing the indicators 5 on a black background. In effect, the first thresholding block B4 binarizes the restricted second greyscale image by assigning black to each pixel having a value lower than a certain threshold and white to all the other pixels. It will be noted that the threshold value is automatically determined in a known manner according to the histogram representing the distribution of the grey levels in an image.

Moreover, the analysis module 93 is configured to automatically analyze the first binary image M2 and the current image M1 captured by the cameras 7, thus automatically determining the positions of the indicators 5 and flow cones 3.

More particularly, the example of FIG. 4C shows the analysis module 93 comprising a first detection block B5, a transformation block B6, a first projection block B7, a second thresholding block B8, a second projection block B9, and a second detection block B10.

The first detection block B5 is configured to take as input the first binary image M2 representing the indicators and to produce as output S1 the coordinates C1 of the centers of gravity of the points representing the indicators 5. The output S1 of the first detection block B5 comprises four coordinates corresponding to the centers of the four white objects 51 of the first binary image M2 thus indicating the positions of the four indicators 5.

The transformation block B6 is configured to determine a projective transformation matrix associating, with each point representing the position of an indicator 5, a corresponding point on a rectangular contour of the first binary image M2. More particularly, the transformation block B6 has two inputs: a first input receiving the four coordinates C1 of the indicators 5 and a second input receiving predetermined coordinates representing the corners of the rectangular contour of the first binary image M2. According to this example, the predetermined coordinates (1, 500), (1, 1), (500, 1) and (500, 500) represent a square delimiting an image with sides of 500 pixels. Thus, the projective transformation matrix makes it possible to switch from the detected points (i.e., coordinates of the indicators) to the desired points (i.e., corners of a 500-pixel image).

The first projection block B7 has two inputs: a first input receiving the greyscale image corresponding to the current image M1 and a second input receiving the projective transformation matrix. This first projection block B7 is configured to apply the projective transformation matrix to the first greyscale image transforming the area of interest 13 of the first greyscale image into a rectangular area of interest 131 delimited by the rectangular contour of the image M3. According to the example of FIG. 4C, the rectangular area of interest 131 is represented by an image M3 with sides of 500 pixels.

Thus, the transformation matrix linearly distorts the area of interest 13 of the first greyscale image into a rectangular area of interest 131, thus producing as output a third greyscale image M3 delimited by the rectangular contour and representing the flow cones 3 of the rectangular area of interest 131. The four corners of the third greyscale image M3 correspond to the positions of the four indicators 5. By eliminating the part outside of the area of interest 13, it becomes possible to have an image M3 not affected by noise from the environment.

The second thresholding block B8 is configured to take as input the third greyscale image M3 representing the rectangular area of interest 131 and to form as output a second binary image M4 (i.e., dichromatic). This second binary image M4 corresponds to the third greyscale image M3 and represents the flow cones 3 of the rectangular area of interest 131 on a monochrome background, the cones being in white on a black background.

The second projection block B9 has two inputs: a first input receiving the second binary image M4 and a second input receiving an inverse matrix of the projective transformation matrix. The second projection block B9 is configured to apply the inverse matrix to the second binary image M4. This inverse matrix rescales the second binary image M4 according to the original scaling of the current image M1, thus producing a third binary image M5 without any object outside of the area of interest 13. This makes it possible to replace the flow cones 3 in the original reference frame while allowing for a better robustness of the detection of these cones 3.

Finally, the second detection block B10 is configured to take as input the third binary image M5 and to produce as output S2 the coordinates C2 of the white spots representing the positions of the flow cones 3. As an example, each cone 3 can be identified by four coordinates representing the corners of a rectangle framing it, or quite simply by two coordinates defining the ends of a segment representing the cone 3. Moreover, it will be noted that the second detection block B10 comprises a filter configured to detect only the objects whose size is limited by predetermined lower and upper bounds as a function of the size of a flow cone 3 and/or the objects which have a particular shape. Thus, the white bands on the third binary image M5 representing adhesives (used only for experimental purposes) are not taken into account for the computation of the coordinates of the flow cones 3.

In the second variant presented above, the analysis module 93 comprises a comparison block B11 for comparing the positions of the flow cones of the current third binary image M5 with the preceding third binary image to produce as output S21 the coordinates C21 of the flow cones 3 which have moved.

The transmission means 11 (see FIG. 1) transmit, to the ground in real time, the positions C2 of all the flow cones 3 or only the positions C21 of those which have moved, and the positions C1 of the indicators 5. Obviously, these data are not bulky and do not take up a lot of bandwidth between the aircraft 5 and the station 21 on the ground. The data received on the ground are displayed in real time on a drawing 23 representing the part of the aircraft corresponding to the area of interest (see FIG. 3).

Advantageously, the transmission means 11 also transmit at least one image M1 captured by the cameras 7 in addition to the coordinates C1, C2 or C21 of the flow cones 3 and of the indicators 5. This makes it possible to display the positions of the indicators 5 and flow cones 3 on the image received from the aircraft.

FIGS. 4D and 4E schematically illustrate the processing means of the management system of FIG. 1, according to another preferred embodiment of the invention.

According to this embodiment, the processing means 9 comprise a display module 95 in addition to the image processing 91 and analysis 93 modules. The image processing 91 and analysis 93 modules are identical to those of FIGS. 4B and 4C.

Moreover, FIG. 4E shows that the display module 95 comprises first B12, second B13 and third B14 graphic representation blocks.

The first graphic representation block B12 is configured to take as input the current image M1 and the data C2 from the output S2 (see FIG. 4C) relating to the positions of the flow cones 3 and to draw, on the current image M1, contours delimiting the cones 3 detected, forming as output a first reconstruction image (not represented). The contour of each flow cone 3 can be defined by a rectangular contour encircling the cone 3 or by a segment passing through the apex and the center of gravity of the cone 3. This makes it possible to identify the orientation and consequently the amplitude of the movement of each cone 3.

The second graphic representation block B13 is configured to take as input the first reconstruction image and the data C1 from the output S1 (see FIG. 4C) relating to the positions of the indicators 5 and to draw, on this first reconstruction image, points representing the positions of the indicators 5, forming as output a second reconstruction image (not represented).

The third graphic representation block B14 is configured to take as input the second reconstruction image and to delimit the area of interest 13, by drawing, on the second reconstruction image, lines linking the points representing the positions of the indicators 5. As output of this third block, a final reconstruction image M6 is formed.

The consecutive final reconstruction images M6 are recorded for example in the storage means onboard the aircraft 15. Thus, the original images are recorded with all the additional data relating to the positions of the indicators and flow cones, consequently allowing for a rapid and accurate analysis of these images offline.

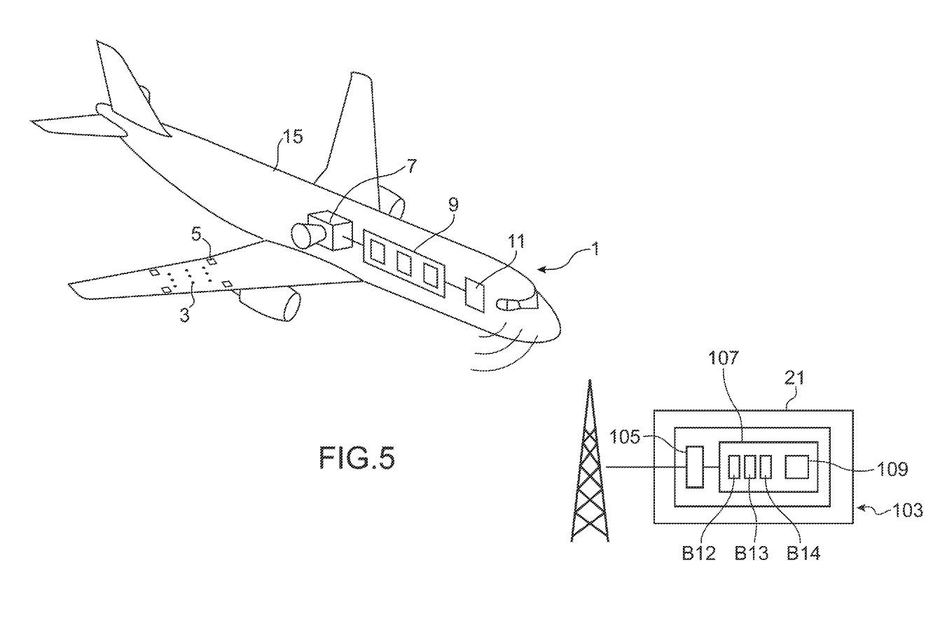

FIG. 5 schematically illustrates a system for analyzing aerodynamic behaviors of an aircraft, according to a preferred embodiment of the invention.

The analysis system 101 comprises a management system 1 onboard the aircraft 15 and an operating system 103 on the ground. The management system 1 comprises, as already illustrated in FIG. 1, flow cones 3, indicators 5, image capture means 7, processing means 9 and transmission means 11.

The processing means 9 comprise image processing 91 and analysis 93 modules as illustrated in FIGS. 4A-4C and optionally a display module 95 as illustrated in FIGS. 4D and 4E.

The operating system 103 on the ground comprises a transceiver unit 105, a data processing unit 107 comprising input means, computation means, storage means, and output means 109 (screen, printer, etc.).

The transceiver unit 105 is configured to receive, in real time from the aircraft 15, data relating to the positions of the indicators 5 and to the positions of the flow cones 3 or only those which have moved. Advantageously, the transceiver unit 105 is configured to also receive from the aircraft 15 a few images of said at least one area of interest 13.

The data processing unit 107 is configured to display on the screen 109 a drawing representing the part of the aircraft comprising the area of interest 13 as illustrated in FIG. 2. The processing unit 107 represents the area of interest 13 and the flow cones 3 on the drawing using the data relating to the positions of the indicators 5 and of the flow cones 3 received from the aircraft 15. Such information reveals the flow cones 3 that are moving and their level of movement, thus facilitating the analysis for the experts analyzing these data.

According to a variant, the data processing unit 107 on the ground implements the display module comprising the first, second and third graphic representation blocks according to FIG. 4E.

In effect, according to this variant, the processing unit 107 takes into account an image M1 received from the aircraft 15 and uses the data relating to the positions of the flow cones 3 and of the indicators 5 to delimit the area of interest 13 and represent the flow cones 3 according to the method of FIG. 4E.

Thus, the experts who follow the test on the ground know automatically and in real time the movements of the flow cones 3 installed on the aircraft 15 and can thus directly and accurately analyze the flow of air crossing the areas of interest while receiving very little data. The experts can also transmit to the crew, through the transceiver unit 105 and in real time, information on conducting the in-flight test.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for real-time management of data relating to an in-flight test of aerodynamic behaviors of an aircraft, comprising:
flow cones installed on at least one area of interest of the aircraft,
indicators installed in said area of interest defining a delimitation of said area of interest,
image capture means associated with the aircraft and configured to capture a stream of images of said area of interest on which the flow cones and the indicators are installed, and
processing means configured to process, in real time and onboard the aircraft, each current image of said stream of images, to automatically identify and determine positions of said indicators and positions of at least some of said flow cones.

2. The system according to claim 1, further comprising a transmission system configured to transmit to the ground, in real time, data relating to said positions of the indicators and of said at least some of the cones.

3. The system according to claim 2, wherein the processing means are configured to automatically determine only the positions of the flow cones that have started moving, the positions of said at least some of said cones transmitted to the ground correspond to the positions of the flow cones which have started moving.

4. The system according to claim 1, wherein said indicators are formed by at least some of said flow cones.

5. The system according to claim 1, wherein the processing means comprise:
an image processing module configured to identify the indicators by transforming said current image into a first binary image representing the indicators on a monochrome background, and
an analysis module configured to analyze said first binary image and said current image to determine the positions of the indicators and of the flow cones.

6. The system according to claim 5, wherein the image processing module comprises:
a selection block configured to take as input said current image and to extract from said current image a color characterizing the indicators, thus forming, as output, an image restricted to said indicators,
a colorimetric conversion block configured to take as input said current image and to produce as output a first greyscale image corresponding to said current image,
a subtraction block configured to take as input the outputs of said selection and conversion blocks and to subtract said greyscale first image from said restricted image producing, as output, a second greyscale image restricted to the indicators, and
a first thresholding block configured to take as input said second greyscale image and to form as output said first binary image representing the indicators on a monochrome background.

7. The system according to claim 5, wherein the analysis module comprises:
a first detection block configured to take as input said first binary image representing the indicators and to produce as output coordinates of points representing the positions of said indicators,
a transformation block configured to determine a projective transformation matrix associating, with each point representing the position of an indicator, a point on a rectangular contour of said first binary image,
a first projection block configured to apply said projective transformation matrix onto the first greyscale image transforming the area of interest of said first greyscale image into a rectangular area of interest delimited by said rectangular contour, thus producing as output a third greyscale image delimited by the rectangular contour and representing the flow cones of said rectangular area of interest,
a second thresholding block configured to take as input said third greyscale image forming as output a second binary image corresponding to said third greyscale image and representing the flow cones of said rectangular area of interest on a monochrome background,
a second projection block configured to apply an inverse matrix of said projective transformation matrix onto said second binary image producing a third binary image without any object outside of the area of interest, and
a second detection block configured to take as input said third binary image and to produce as output coordinates indicating the positions of said flow cones.

8. The system according to claim 7, wherein the analysis module further comprises a comparison block configured to compare the positions of the flow cones of said third current binary image with those of the preceding image, thus automatically identifying the flow cones which start to move such that the positions of said at least some of said cones transmitted to the ground relate to the flow cones which have started moving.

9. The system according to claim 1, wherein the processing means further comprise a display module comprising:
a first graphic representation block configured to take as input said current image and the data relating to the positions of said at least some of the cones and to draw on said current image contours delimiting the detected cones, forming as output a first reconstruction image,
a second graphic representation block configured to take as input said first reconstruction image and the data relating to the positions of the indicators and to draw on said first reconstruction image points representing the positions of the indicators, forming as output a second reconstruction image,
a third graphic representation block configured to take as input said second reconstruction image and to delimit said area of interest by drawing on said second reconstruction image lines linking the points representing the positions of the indicators forming as output a final reconstruction image.

10. An operating system for data relating to an in-flight test received in real time from an aircraft, said data being acquired from a system for real-time management of data according to claim 1, the operating system comprising:
a transceiver unit configured to receive, in real time from the aircraft, said data relating to the positions of the indicators and of said at least some of the flow cones, and
a data processing unit configured to display the positions of the indicators on a drawing representing the part of the aircraft comprising the area of interest.

11. A system for analyzing aerodynamic behaviors of an aircraft, comprising a system for real-time management of data relating to an in-flight test of aerodynamic behaviors of an aircraft, comprising:
flow cones installed on at least one area of interest of the aircraft,
indicators installed in said area of interest defining a delimitation of said area of interest,
image capture means associated with the aircraft and configured to capture a stream of images of said area of interest on which the flow cones and the indicators are installed, and
processing means configured to process, in real time and onboard the aircraft, each current image of said stream of images, to automatically identify and determine positions of said indicators and positions of at least some of said flow cones, and
an operating system comprising:
a transceiver unit configured to receive, in real time from the aircraft, said data relating to the positions of the indicators and of said at least some of the flow cones, and
a data processing unit configured to display the positions of the indicators on a drawing representing the part of the aircraft comprising the area of interest.

12. A method for processing, in real time, a stream of images taken onboard an aircraft in an in-flight test of aerodynamic behaviors of said aircraft, said images relating to an area of interest of the aircraft on which flow cones and indicators are installed, said method comprising:
processing, in real time and onboard the aircraft, of each current image of said stream of images to automatically identify and determine positions of said indicators and positions of at least some of said flow cones.

13. The method according to claim 12, further comprising a step of transmitting, to the ground in real time, data relating to said positions of the indicators and of said at least some of the cones.

14. The method according to claim 12, further comprising the steps:
identifying the indicators by transforming each current image of said stream of images into a first binary image representing the indicators on a monochrome background, and
analysing said first binary image and said current image to determine the positions of the indicators and of said at least some of the flow cones.

15. The method according to claim 14, wherein the identification of the indicators comprises the steps:
extracting a color characterizing the indicators of said current image to form an image restricted to said indicators,
producing a first greyscale image corresponding to said current image,
subtracting said first greyscale image from said restricted image to produce a second greyscale image restricted to the indicators, and
thresholding said second greyscale image to form said first binary image representing the indicators on a monochrome background.

16. The method according to claim 14, wherein the analysis of said first binary image and of said current image for the determination of the positions of the indicators and of the flow cones comprises the steps:
determining coordinates of the points representing the positions of said indicators from said first binary image,
determining a projective transformation matrix associating, with each point representing the position of an indicator, a point on a rectangular contour of said first binary image,
applying said projective transformation matrix onto the first greyscale image to transform the area of interest of said first greyscale image into a rectangular area of interest delimited by said rectangular contour thus producing a third greyscale image delimited by the rectangular contour and representing the flow cones of said rectangular area of interest,
thresholding said third greyscale image to form a second binary image representing the flow cones of said rectangular area of interest on a monochrome background,
applying an inverse matrix of said projective transformation matrix onto said second binary image to produce a third binary image without any object outside of the area of interest, and
determining the coordinates indicating the positions of said flow cones from said third binary image.

17. The method according to claim 16, further comprising a comparison of the positions of the flow cones of said third current binary image with those of the preceding image to automatically identify the flow cones which start to move.

18. The method according to claim 14, further comprising the following steps:
drawing contours delimiting the flow cones on said current image to form a first reconstruction image,
drawing points representing the positions of the indicators on said first reconstruction image to form a second reconstruction image, and
drawing lines linking the points representing the positions of the indicators on said second reconstruction image to form a final reconstruction image.

19. A computer program comprising code instructions for the implementation of the processing method according to claim 14 when it is run by a processing means.
